(19) United States
(12) Patent Application Publication
(10) Pub. No.: US 2025/0044673 A1
(43) Pub. Date: Feb. 6, 2025

(54) WAVELENGTH CONVERSION ELEMENT, ILLUMINATION SYSTEM, AND PROJECTION DEVICE

(71) Applicant: Coretronic Corporation, Hsin-Chu (TW)

(72) Inventor: Shih-Chen Chiou, Hsin-Chu (TW)

(73) Assignee: Coretronic Corporation, Hsin-Chu (TW)

(21) Appl. No.: 18/774,905

(22) Filed: Jul. 16, 2024

(30) Foreign Application Priority Data
Jul. 31, 2023 (CN) 202310946672.0

(51) Int. Cl. G03B 21/20; G02B 26/00

(52) U.S. Cl. CPC G03B 21/204; G02B 26/008; G03B 21/208

(57) ABSTRACT

A wavelength conversion element is adapted to rotate around a rotation axis. The wavelength conversion element includes a rotating member and a wavelength conversion material. The wavelength conversion material is arranged on the rotating member. The wavelength conversion material is configured to convert a laser beam into a conversion beam. The rotating member is configured to drive the wavelength conversion material to rotate around the rotation axis. The wavelength conversion element has a light-transmitting area. The light-transmitting area is surrounded by the rotating member. The light-transmitting area is configured to allow at least one of the laser beam and the conversion beam to pass through.

### CROSS-REFERENCE TO RELATED APPLICATION

This application claims the priority benefit of China application serial no. 202310946672.0, filed on Jul. 31, 2023. The entirety of the above-mentioned patent application is hereby incorporated by reference herein and made a part of this specification.

### BACKGROUND

### Technical Field

The disclosure relates to an optical element, an optical system, and an electronic device, and in particular relates to a wavelength conversion element, an illumination system, and a projection device.

### Description of Related Art

A projection device is a display device used to produce large-size images, which has been constantly improving with the evolution and innovation of technology. The imaging principle of the projection device is to convert an illumination beam generated by an illumination system into an image beam through a light valve, and then project the image beam onto a projection target (such as a screen or wall) through a projection lens to form a projection image.

A fluorescent wheel is one of the elements commonly used in projection devices. The fluorescent wheel rotates a wheel with a motor in the center of the wheel, and the wheel can be coated with fluorescent powder. When the section of the fluorescent powder is rotated into the transmission path of the beam, the beam excites the fluorescent powder to produce a color light corresponding to the fluorescent powder. However, as the motor of the fluorescent wheel occupies a certain space, there is still room for improvement in terms of miniaturization. How to develop an optical architecture that can reduce the size is one of the goals in this field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a wavelength conversion element, an illumination system, and a projection device which improve the utilization of the space inside the wavelength conversion element.

Other objectives and advantages of the disclosure can be further understood from the technical features disclosed hereinafter.

In order to achieve one, part, or all of the above objectives or other objectives, an embodiment of the disclosure provides a wavelength conversion element adapted to rotate around a rotation axis. The wavelength conversion element includes a rotating member and a wavelength conversion material. The wavelength conversion material is arranged on the rotating member. The wavelength conversion material is configured to convert a laser beam into a conversion beam. The rotating member is configured to drive the wavelength conversion material to rotate around the rotation axis. The wavelength conversion element has a light-transmitting area. The light-transmitting area is surrounded by the rotating member. The light-transmitting area is configured to allow at least one of the laser beam and the conversion beam to pass through.

In order to achieve one, part, or all of the above objectives or other objectives, an embodiment of the disclosure provides an illumination system, including a light source module, a transflective element, a wavelength conversion element, and a first light splitting element. The light source module is configured to provide a laser beam. The laser beam includes a first part and a second part. The transflective element is arranged on a transmission path of the laser beam and configured to allow one of the first part and the second part to pass through and reflect the other one of the first part and the second part. The wavelength conversion element is arranged on a transmission path of the second part of the laser beam. The wavelength conversion element is adapted to rotate around a rotation axis. The wavelength conversion element includes a rotating member and a wavelength conversion material. The wavelength conversion material is arranged on the rotating member. The wavelength conversion material is configured to convert the laser beam into a conversion beam. The rotating member is configured to drive the wavelength conversion material to rotate around the rotation axis. The wavelength conversion element has a light-transmitting area. The light-transmitting area is surrounded by the rotating member. The light-transmitting area is configured to allow at least one of the laser beam and the conversion beam to pass through. The first light splitting element is arranged on a transmission path of the laser beam and the conversion beam and configured to allow one of the laser beam and the conversion beam to pass through and reflect the other one of the laser beam and the conversion beam. The illumination beam includes at least one of the first part of the laser beam and the conversion beam.

In order to achieve one, part, or all of the above objectives or other objectives, an embodiment of the disclosure provides a projection device including an illumination system, at least one light valve, and a projection lens. The illumination system is configured to provide an illumination beam. The illumination system includes a light source module, a transflective element, a wavelength conversion element, and a first light splitting element. The light source module is configured to provide a laser beam. The laser beam includes a first part and a second part. The transflective element is arranged on a transmission path of the laser beam and configured to allow one of the first part and the second part to pass through and reflect the other one of the first part and the second part. The wavelength conversion element is arranged on a transmission path of the second part of the laser beam. The wavelength conversion element is adapted to rotate around a rotation axis. The wavelength conversion element includes a rotating member and a wavelength conversion material. The wavelength conversion material is arranged on the rotating member. The wavelength conversion material is configured to convert the laser beam into a conversion beam. The rotating member is configured to drive the wavelength conversion material to rotate around the rotation axis. The wavelength conversion element has a light-transmitting area. The light-transmitting area is surrounded by the rotating member. The light-transmitting area is configured to allow at least one of the laser beam and the conversion beam to pass through. The first light splitting element is arranged on a transmission path of the conversion beam and configured to allow one of the laser beam and the conversion beam to pass through and reflect the other one of the laser beam and the conversion beam. The illumination beam includes at least one of the first part of the laser beam and the conversion beam. The at least one light valve is arranged on a transmission path of the illumination beam and configured to convert the illumination beam into an image beam. The projection lens is arranged on a transmission path of the image beam and configured to project the image beam out of the projection device.

Based on the above, the embodiments of the disclosure have at least one of the following advantages or effects. In the wavelength conversion element, the illumination system, and the projection device of the disclosure, the wavelength conversion element includes the rotating member and the wavelength conversion material. The wavelength conversion element has the light-transmitting area, which is surrounded by the rotating member. The light-transmitting area is configured to allow at least one of the laser beam and the conversion beam to pass through. Thus, the wavelength conversion element has an effect of converting the wavelength of a beam, and in terms of the optical design architecture, the light-transmitting area of the wavelength conversion element may be arranged on the transmission path of the beam, thereby improving the utilization of the space inside the wavelength conversion element.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A to FIG. 1C are schematic views of the wavelength conversion element according to the first embodiment of the disclosure from different perspectives.

FIG. 2A to FIG. 2C are schematic views of the wavelength conversion element according to the second embodiment of the disclosure from different perspectives.

FIG. 3 is a schematic view of the wavelength conversion element according to the third embodiment of the disclosure.

FIG. 4 is a schematic view of the projection device according to an embodiment of the disclosure.

FIG. 5 is a schematic view of the illumination system according to the first embodiment of the disclosure.

FIG. 6 is a schematic view of the illumination system according to the second embodiment of the disclosure.

FIG. 7 is a schematic view of the illumination system according to the third embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

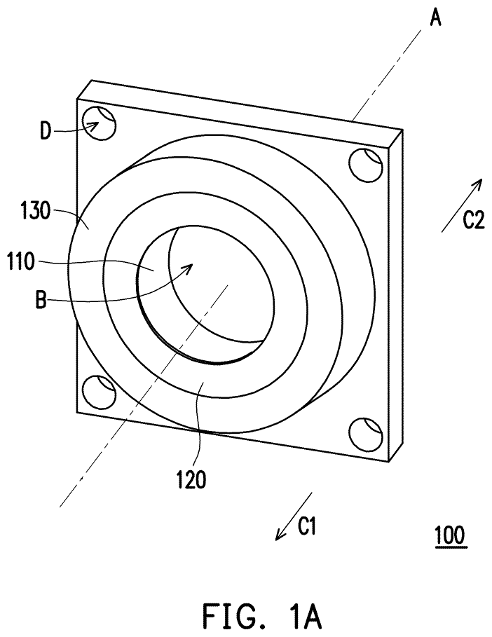

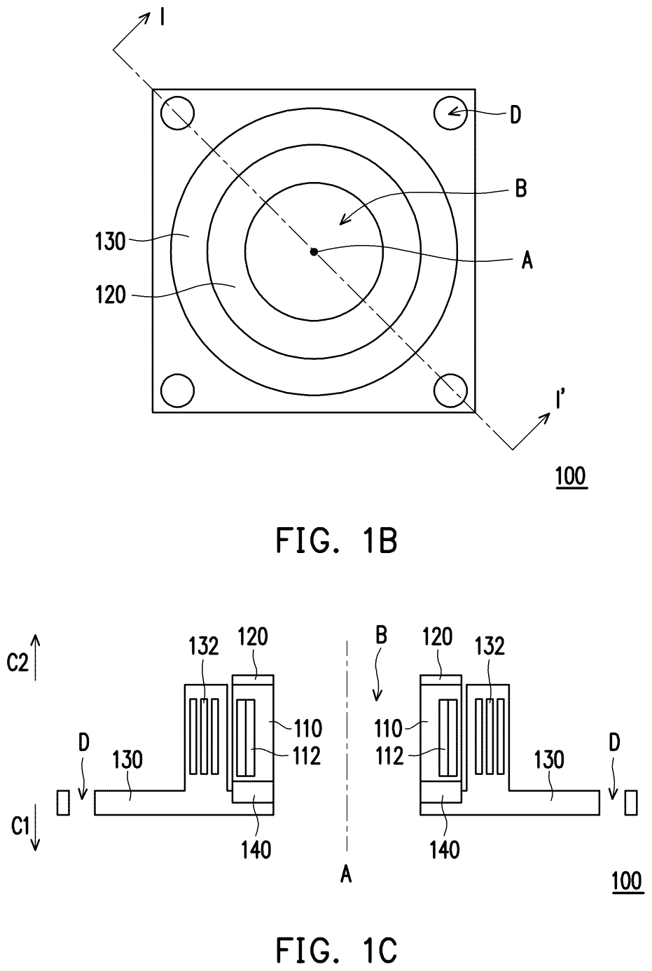

FIG. 1A to FIG. 1C are schematic views of a wavelength conversion element according to the first embodiment of the disclosure from different perspectives. FIG. 1C is a schematic cross-sectional view along the line I-I′ of FIG. 1B. Referring to FIG. 1A to FIG. 1C, this embodiment provides a wavelength conversion element (fluorescent wheel) 100 which is adapted to rotate around a rotation axis A. The wavelength conversion element 100 includes a rotating member 110 and a wavelength conversion material 120. The wavelength conversion material 120 is arranged on the rotating member 110, and the wavelength conversion material 120 is configured to convert a laser beam into a conversion beam of a different wavelength. In this embodiment, the wavelength conversion material 120 is, for example, a yellow fluorescent material configured to convert a blue laser beam into a yellow beam. The wavelength conversion material 120 may have a ring shape or a sector shape. The rotating member 110 is configured to drive the wavelength conversion material 120 to rotate around the rotation axis A. The wavelength conversion element 100 has a light-transmitting area B. The light-transmitting area B is surrounded by the rotating member 110. The rotation axis A is located in the light-transmitting area B. The light-transmitting area B is configured to allow a beam to pass through.

The wavelength conversion element 100 has a first side C1 and a second side C2 opposite to each other in an extending direction of the rotation axis A, and the wavelength conversion material 120 is arranged on a surface of the rotating member 110 facing the first side C1. Specifically, in this embodiment, the wavelength conversion element 100 further includes a fixing member 130 and a bearing structure 140. The fixing member 130 surrounds the light-transmitting area B and the rotating member 110. In other words, on a reference plane perpendicular to the rotation axis A, the rotating member 110 is located between the fixing member 130 and the light-transmitting area B, and the rotating member 110 and the fixing member 130 have a coaxial structure. In an embodiment, the fixing member 130 may be provided with a plurality of fastening holes D for fastening the wavelength conversion element 100 to an illumination system 200 with fixing elements such as screws (shown in FIG. 4). The bearing structure 140 is connected to the rotating member 110 and is arranged on a side of the rotating member 110 facing the second side C2. In this embodiment, the radius of the bearing structure 140 is the same as the radius of the rotating member 110. The bearing structure 140 is adapted to carry the rotating member 110 and rotate together. For example, the rotating member 110 may include a magnetic structure (for example, a magnet) 112, and the rotating member 110 may be a metal ring. The fixing member 130 includes a coil structure (for example, a copper coil) 132, which energizes the fixing member 130 based on the principle of a motor to cause the rotating member 110 to rotate through the bearing structure (bearing) 140, thereby driving the wavelength conversion material 120 to rotate.

Therefore, the wavelength conversion element 100 of this embodiment is enabled to rotate without using a motor, so the wavelength conversion element 100 has a favorable heat dissipation effect. The wavelength conversion element 100 has an effect of converting the wavelength of a beam, and in terms of the optical design architecture, the light-transmitting area B of the wavelength conversion element 100 may be arranged on the transmission path of a beam, and optical elements may be further arranged in the light-transmitting area B to improve the utilization of the space inside the wavelength conversion element 100. Furthermore, there is a gap between the rotating member 110 and the fixing member 130 in this embodiment. Therefore, the wavelength conversion element 100 achieves effects of low noise and anti-vibration.

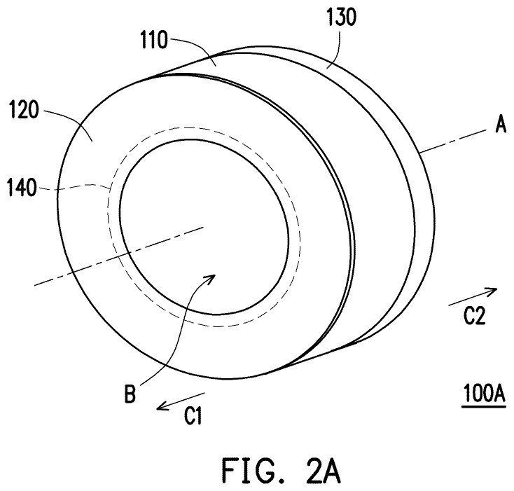

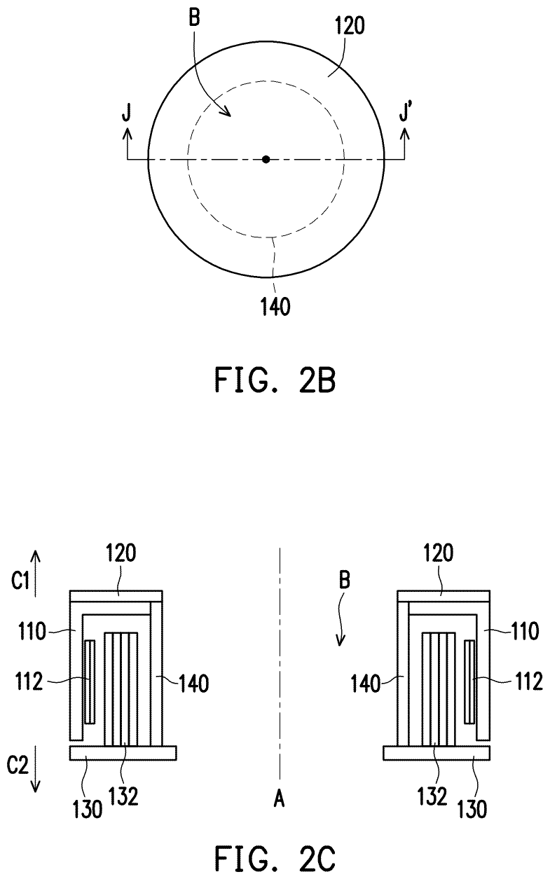

FIG. 2A to FIG. 2C are schematic views of a wavelength conversion element according to the second embodiment of the disclosure from different perspectives. FIG. 2C is a schematic cross-sectional view along the line J-J′ of FIG. 2B. Referring to FIG. 2A to FIG. 2C, the structure and advantages of the wavelength conversion element 100A of this embodiment are similar to those of the embodiment of FIG. 1A to FIG. 1C, and only the differences will be described below. In this embodiment, the rotating member 110 surrounds the bearing structure 140. On the reference plane perpendicular to the rotation axis A, the bearing structure 140 is located between the rotating member 110 and the light-transmitting area B, and the fixing member 130 is arranged on the surface of the rotating member 110 facing the second side C2. The rotating member 110 and the bearing structure 140 are combined to form an accommodation space, which allows the coil structure 132 of the fixing member 130 to be located between the magnetic structure 112 of the rotating member 110 and the bearing structure 140. There is a gap between the coil structure 132 and the magnetic structure 112. The wavelength conversion material 120 is arranged on the surface of the rotating member 110 facing the first side C1. The radius of the bearing structure 140 is smaller than the radius of the rotating member 110.

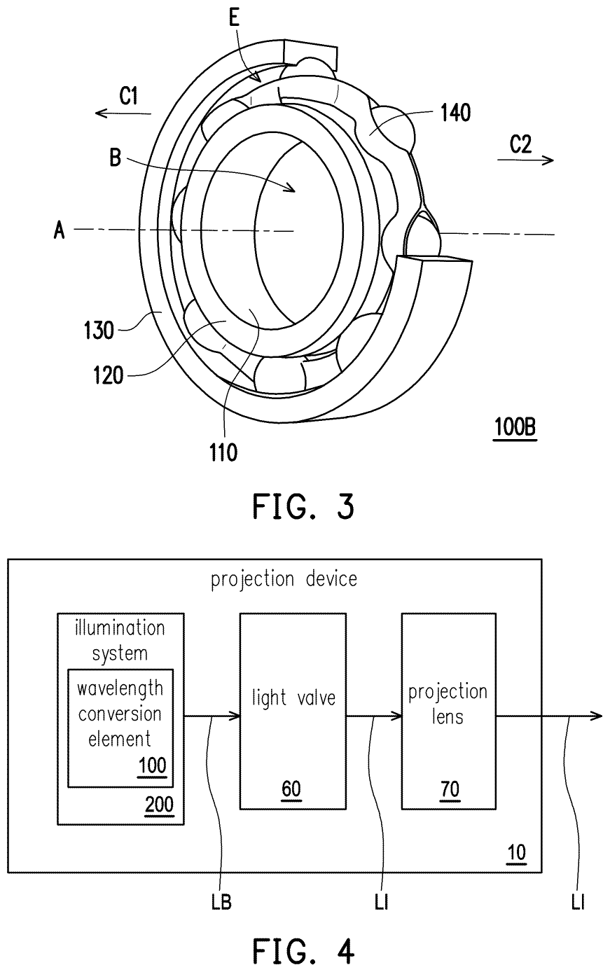

FIG. 3 is a schematic view of a wavelength conversion element according to the third embodiment of the disclosure. Referring to FIG. 3, the structure and advantages of the wavelength conversion element 100B of this embodiment are similar to those of the embodiment of FIG. 1A to FIG. 1C, and only the differences will be described below. In this embodiment, the rotating member 110 and the fixing member 130 form an annular groove E, and the bearing structure 140 is arranged between the rotating member 110 and the fixing member 130 and is located in the annular groove E. Therefore, when the fixing member 130 is energized, the rotating member 110 rotates through the bearing structure 140 located in the annular groove E, thereby driving the wavelength conversion material 120 to rotate. In this embodiment, the fixing member 130 surrounds the rotating member 110. However, in another embodiment, the rotating member 110 may be arranged to surround the fixing member 130.

FIG. 4 is a schematic view of a projection device according to an embodiment of the disclosure. Referring to FIG. 4, the projection device (projector) 10 of this embodiment includes an illumination system 50, at least one light valve 60, and a projection lens 70. The illumination system 50 includes the wavelength conversion element 100 of any of the foregoing embodiments. The illumination system 50 is configured to provide an illumination beam LB. The at least one light valve 60 is arranged on the transmission path of the illumination beam LB and configured to convert the illumination beam LB into an image beam LI. The projection lens 70 is arranged on the transmission path of the image beam LI and is configured to project the image beam LI out of the projection device 10 to a projection target (not shown) such as a screen or wall.

The light valve 60 is, for example, a reflective optical modulator such as a liquid crystal on silicon panel (LCOS panel) and a digital micro-mirror device (DMD). In some embodiments, the light valve 60 may also be a transmissive optical modulator such as a transparent liquid crystal panel, an electro-optical modulator, a magneto-optic modulator, and an acousto-optic modulator (AOM). The disclosure is not intended to limit the form and type of the light valve 60. The detailed steps and implementation for the light valve 60 to convert the illumination beam LB into the image beam LI can be sufficiently understood from the teachings, suggestions, and descriptions of the common knowledge in the field, and therefore will not be repeated here. In this embodiment, the number of the light valves 60 may be one to three, that is, an optical architecture of 1DMD, 2DMD, or 3DMD.

The projection lens 70 includes, for example, one optical lens with refractive power or a combination of more optical lenses with refractive power, for example, various combinations of non-planar lenses such as biconcave lenses, biconvex lenses, concave-convex lenses, convex-concave lenses, plano-convex lenses, and plano-concave lenses. In an embodiment, the projection lens 70 may further include a planar optical lens to project the image beam LI from the light valve 60 to the projection target in a reflective manner. The disclosure is not intended to limit the form and type of the projection lens 70.

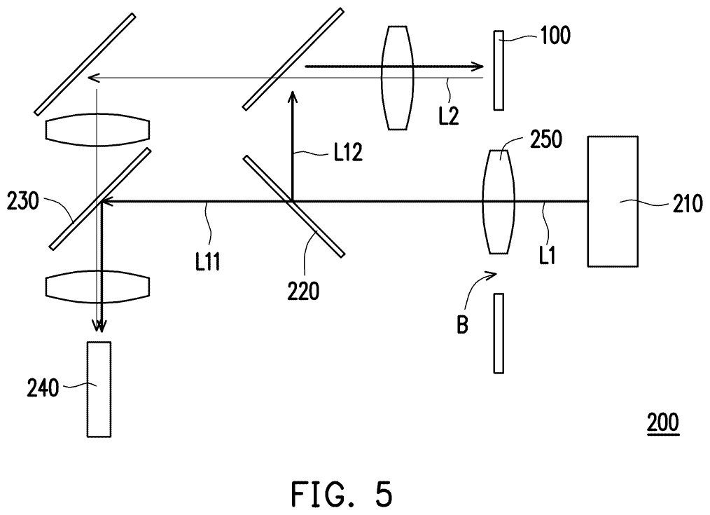

FIG. 5 is a schematic view of an illumination system according to the first embodiment of the disclosure. The illumination system 200 of this embodiment is applicable to at least the projection device 10 of FIG. 4. Referring to FIG. 5, in this embodiment, the illumination system 200 includes a light source module 210, a transflective element 220, a wavelength conversion element 100, and a first light splitting element 230. The light source module 210 is configured to provide a laser beam L1, and the laser beam L1 includes a first part L11 and a second part L12. The light source module 210 includes at least one light-emitting element. The at least one light-emitting element is, for example, a light-emitting diode, a laser diode, or a combination of the foregoing. The laser beam L1 is a blue beam.

The transflective element 220 is arranged on the transmission path of the laser beam L1 to allow one of the first part L11 and the second part L12 of the laser beam L1 to pass through and reflect the other. For example, in this embodiment, the transflective element 220 is configured to allow the first part L11 to pass through and reflect the second part L12. In other words, the transflective element 220 reflects 50% of the laser beam L1 and allows the other 50% of the laser beam L1 to pass through. In this embodiment, the transflective element 220 is, for example, a transflective mirror or a light-transmissive element coated with a film that reflects 50% of the laser beam L1.

The wavelength conversion element 100 is arranged on the transmission path of the second part L12 of the laser beam L1, and the wavelength conversion material 120 in the wavelength conversion element 100 is configured to convert the laser beam L1 into a conversion beam L2. In this embodiment, the wavelength conversion element 100 is arranged between the light source module 210 and the transflective element 220. That is, the light source module 210 is located on a side of the wavelength conversion element 100 facing the second side C2 (shown in FIG. 1A). A light-transmitting area B of the wavelength conversion element 100 is located on the transmission path of the laser beam L1 from the light source module 210. Therefore, the laser beam L1 from the light source module 210 passes through the light-transmitting area B of the wavelength conversion element 100 and then enters the transflective element 220.

The first light splitting element 230 is arranged on the transmission path of the first part L11 of the laser beam L1 and the conversion beam L2, and is configured to allow one of the laser beam L1 and the conversion beam L2 to pass through and reflect the other. For example, in this embodiment, the first light splitting element 230 is configured to allow the conversion beam L2 to pass through and reflect the laser beam L1 (that is, the first part L11). Therefore, the first light splitting element 230 is adapted to guide the first part L11 of the laser beam L1 and the conversion beam L2 to the same transmission path. The first light splitting element 230 is, for example, a blue light-reflective splitter or an optical element coated with a film that reflects a blue light band. In other embodiments, the illumination system 200 may further include a reflector for guiding at least one of the laser beam L1 and the conversion beam L2.

In this embodiment, the illumination system 200 may further include a light uniformizing element 240 which is arranged on the transmission path of the first part L11 of the laser beam L1 and the conversion beam L2. The illumination beam LB includes at least one of the first part L11 of the laser beam L1 and the conversion beam L2. In this embodiment, since the first part L11 and the second part L12 of the laser beam L1 are transmitted simultaneously, the first part L11 of the laser beam L1 and the conversion beam L2 may be transmitted to the light uniformizing element 240 at the same time sequence, and then form multiple optical paths through a light splitting element (not shown in the drawing) to respectively enter multiple light valves 60. The illumination system 200 of this embodiment does not require a filter wheel. In this embodiment, the transflective element 220, the first light splitting element 230, and the light uniformizing element 240 are located on a side of the wavelength conversion element 100 facing the first side C1 (shown in FIG. 1A). The light uniformizing element 240 is configured to adjust the shape of the light spot formed by the illumination beam LB on the light valve 60. The light uniformizing element 240 is, for example, an integrating rod or a lens array (fly eye lens array).

In this embodiment, the illumination system 200 may further include an optical lens 250, such as a condenser lens, arranged in the light-transmitting area B of the wavelength conversion element 100 to allow at least one of the laser beam L1 and the conversion beam L2 to pass through. The orthographic projection of the optical lens 250 on the rotation axis A and the orthographic projection of the wavelength conversion element 100 on the rotation axis A at least partially overlap. For example, the optical lens 250 may be arranged in the light-transmitting area B through a support member such as a bracket. In this embodiment, the light-transmitting area B of the wavelength conversion element 100 is configured to allow the laser beam L1 from the light source module 210 to pass through. Thus, by disposing other required optical elements (for example, the optical lens 250) in the light-transmitting area B of the wavelength conversion element 100, the utilization of the space inside the wavelength conversion element 100 can be further improved to reduce the size of the illumination system 200 and the projection device 10.

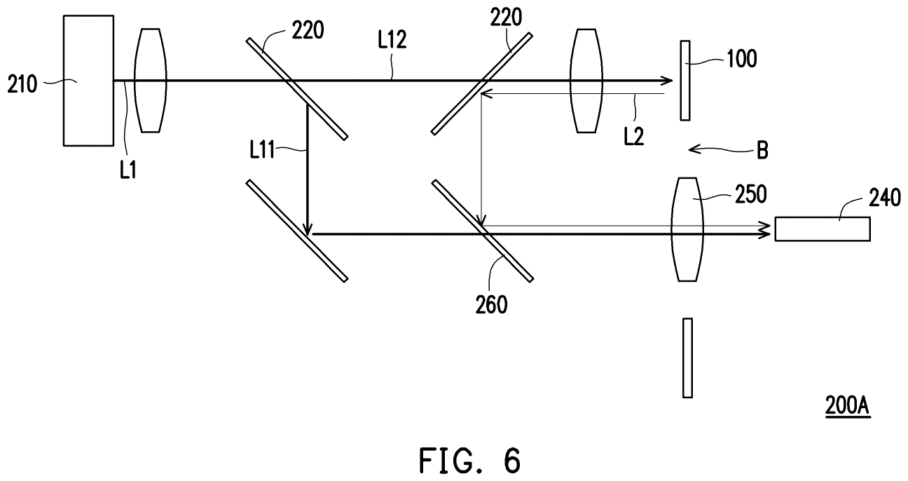

FIG. 6 is a schematic view of an illumination system according to the second embodiment of the disclosure. Referring to FIG. 6, the structure and advantages of the illumination system 200A of FIG. 6 are similar to those of the illumination system 200 of FIG. 5, and only the differences will be described below. In this embodiment, the transflective element 220 is configured to allow the second part L12 of the laser beam L1 to pass through and reflect the first part L11 of the laser beam L1. The first light splitting element 230 is arranged on the transmission path of the second part L12 of the laser beam L1 and the conversion beam L2, and is configured to allow the laser beam L1 (that is, the second part L12) to pass through and reflect the conversion beam L2. The first light splitting element 230 is, for example, a green and red light-reflective splitter or an optical element coated with a film that reflects green and red light bands. In addition, in this embodiment, the illumination system 200A also includes a second light splitting element 260 which is arranged on the transmission path of the first part L11 of the laser beam L1 and the conversion beam L2 to allow the laser beam L1 (that is, the first part L11) to pass through and reflect the conversion beam L2. In this embodiment, the wavelength conversion element 100 is arranged between the light uniformizing element 240 and the second light splitting element 260, and the light-transmitting area B of the wavelength conversion element 100 is located on the transmission path of the laser beam L1 (that is, the first part L11) from the second light splitting element 260 and the conversion beam L2. In this embodiment, the transmission path of the laser beam L1 provided by the light source module 210 is parallel to the rotation axis A of the wavelength conversion element 100 (shown in FIG. 1A to FIG. 3). In this embodiment, the light source module 210, the transflective element 220, and the first light splitting element 230 are located on a side of the wavelength conversion element 100 facing the first side C1 (shown in FIG. 1A). The light uniformizing element 240 is located on a side of the wavelength conversion element 100 facing the second side C2 (shown in FIG. 1A).

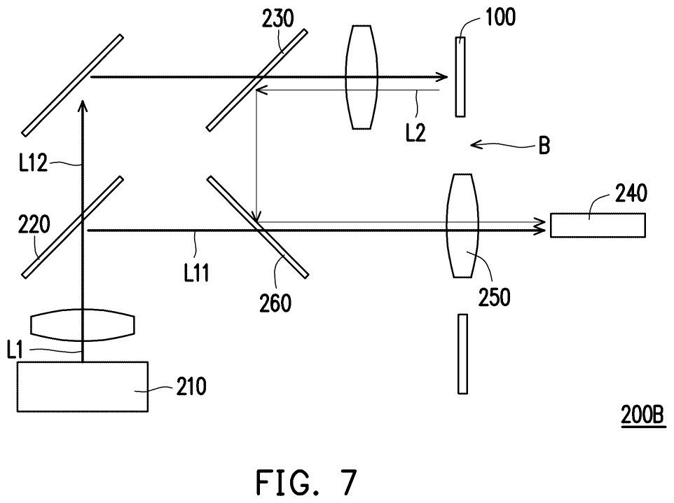

FIG. 7 is a schematic view of an illumination system according to the third embodiment of the disclosure. Referring to FIG. 7, the structure and advantages of the illumination system 200B of FIG. 7 are similar to those of the illumination system 200A of FIG. 6, and only the differences will be described below. In this embodiment, the transmission path of the laser beam L1 provided by the light source module 210 of the illumination system 200B is perpendicular to the rotation axis A of the wavelength conversion element 100 (shown in FIG. 1A to FIG. 3).

To sum up, in the wavelength conversion element, the illumination system, and the projection device of the disclosure, the wavelength conversion element includes the rotating member and the wavelength conversion material. The wavelength conversion element has the light-transmitting area, which is surrounded by the rotating member. The light-transmitting area is configured to allow at least one of the laser beam and the conversion beam to pass through. Thus, the wavelength conversion element has an effect of converting the wavelength of a beam, and in terms of the optical design architecture, the light-transmitting area of the wavelength conversion element may be arranged on the transmission path of the beam, thereby improving the utilization of the space inside the wavelength conversion element to reduce the size of the illumination system and the projection device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no clement and component in the disclosure is intended to be dedicated to the public regardless of whether the clement or component is explicitly recited in the following claims.

What is claimed is:

1. A wavelength conversion element, adapted to rotate around a rotation axis, the wavelength conversion element comprising:
a rotating member; and
a wavelength conversion material,
wherein the wavelength conversion material is arranged on the rotating member, and the wavelength conversion material is configured to convert a laser beam into a conversion beam,
the rotating member is configured to drive the wavelength conversion material to rotate around the rotation axis, and
the wavelength conversion element has a light-transmitting area that is surrounded by the rotating member, and the light-transmitting area is configured to allow at least one of the laser beam and the conversion beam to pass through.

2. The wavelength conversion element according to claim 1, further comprising a fixing member and a bearing structure,
wherein the fixing member surrounds the light-transmitting area, the bearing structure is connected to the rotating member, the wavelength conversion element has a first side and a second side opposite to each other in an extending direction of the rotation axis, and the wavelength conversion material is arranged on a surface of the rotating member facing the first side.

3. The wavelength conversion element according to claim 2, wherein the fixing member surrounds the rotating member, and the bearing structure is arranged on a side of the rotating member facing the second side.

4. The wavelength conversion element according to claim 3, wherein a radius of the bearing structure is the same as a radius of the rotating member.

5. The wavelength conversion element according to claim 2, wherein the rotating member surrounds the bearing structure, the bearing structure is located between the rotating member and the light-transmitting area, and the fixing member is arranged on a surface of the rotating member facing the second side.

6. The wavelength conversion element according to claim 5, wherein a radius of the bearing structure is smaller than a radius of the rotating member.

7. The wavelength conversion element according to claim 2, wherein the rotating member and the fixing member form an annular groove, and the bearing structure is arranged between the rotating member and the fixing member and located in the annular groove.

8. An illumination system, configured to provide an illumination beam, the illumination system comprising:
a light source module;
a transflective element;
a wavelength conversion element; and
a first light splitting element,
wherein the light source module is configured to provide a laser beam, and the laser beam includes a first part and a second part,
the transflective element is arranged on a transmission path of the laser beam and allows one of the first part and the second part to pass through and reflects the other one of the first part and the second part,
the wavelength conversion element is arranged on a transmission path of the second part of the laser beam, the wavelength conversion element is adapted to rotate around a rotation axis, and
the wavelength conversion element comprises a rotating member and a wavelength conversion material,
wherein the wavelength conversion material is arranged on the rotating member, and the wavelength conversion material is configured to convert the laser beam into a conversion beam,
the rotating member is configured to drive the wavelength conversion material to rotate around the rotation axis, and
the wavelength conversion element has a light-transmitting area that is surrounded by the rotating member, and the light-transmitting area is configured to allow at least one of the laser beam and the conversion beam to pass through, and
the first light splitting element is arranged on a transmission path of the laser beam and the conversion beam and configured to allow one of the laser beam and the conversion beam to pass through and reflect the other one of the laser beam and the conversion beam, and the illumination beam includes at least one of the first part of the laser beam and the conversion beam.

9. The illumination system according to claim 8, further comprising a light uniformizing element arranged on a transmission path of the first part of the laser beam and the conversion beam.

10. The illumination system according to claim 8, wherein the wavelength conversion element further comprises a fixing member and a bearing structure,
wherein the fixing member surrounds the light-transmitting area, the bearing structure is connected to the rotating member, the wavelength conversion element has a first side and a second side opposite to each other in an extending direction of the rotation axis, and the wavelength conversion material is arranged on a surface of the rotating member facing the first side.

11. The illumination system according to claim 10, wherein the fixing member surrounds the rotating member, and the bearing structure is arranged on a side of the rotating member facing the second side.

12. The illumination system according to claim 11, wherein a radius of the bearing structure is the same as a radius of the rotating member.

13. The illumination system according to claim 10, wherein the rotating member surrounds the bearing structure, the bearing structure is located between the rotating member and the light-transmissing area, and the fixing member is arranged on a surface of the rotating member facing the second side.

14. The illumination system according to claim 13, wherein a radius of the bearing structure is smaller than a radius of the rotating member.

15. The illumination system according to claim 10, wherein the rotating member and the fixing member form an annular groove, and the bearing structure is arranged between the rotating member and the fixing member and located in the annular groove.

16. The illumination system according to claim 8, further comprising an optical lens arranged in the light-transmitting area of the wavelength conversion element and configured to allow at least one of the laser beam and the conversion beam to pass through.

17. The illumination system according to claim 8, wherein the transflective element is configured to allow the first part of the laser beam to pass through and reflect the second part of the laser beam, and the first light splitting element is configured to allow the conversion beam to pass through and reflect the laser beam.

18. The illumination system according to claim 17, wherein the wavelength conversion element is arranged between the light source module and the transflective element, and the light-transmitting area of the wavelength conversion element is located on the transmission path of the laser beam from the light source module.

19. The illumination system according to claim 8, wherein the transflective element is configured to allow the second part of the laser beam to pass through and reflect the first part of the laser beam, the first light splitting element is configured to allow the laser beam to pass through and reflect the conversion beam, and the illumination system further comprises a second light splitting element arranged on a transmission path of the first part of the laser beam and the conversion beam and configured to allow the laser beam to pass through and reflect the conversion beam.

20. The illumination system according to claim 19, further comprising a light uniformizing element arranged on the transmission path of the first part of the laser beam and the conversion beam, the wavelength conversion element is arranged between the light uniformizing element and the second light splitting element, and the light-transmitting area of the wavelength conversion element is located on a transmission path of the laser beam from the second light splitting element and the conversion beam.

21. The illumination system according to claim 8, wherein the transmission path of the laser beam provided by the light source module is parallel to the rotation axis of the wavelength conversion element.

22. The illumination system according to claim 8, wherein the transmission path of the laser beam provided by the light source module is perpendicular to the rotation axis of the wavelength conversion element.

23. A projection device, comprising:
an illumination system;
at least one light valve; and
a projection lens,
wherein the illumination system is configured to provide an illumination beam, and the illumination system comprises a light source module, a transflective element, a wavelength conversion element, and a first light splitting element,
wherein the light source module is configured to provide a laser beam, and the laser beam includes a first part and a second part,
the transflective element is arranged on a transmission path of the laser beam and configured to allow one of the first part and the second part to pass through and reflect the other one of the first part and the second part,
the wavelength conversion element is arranged on a transmission path of the second part of the laser beam, the wavelength conversion element is adapted to rotate around a rotation axis, and the wavelength conversion element comprises a rotating member and a wavelength conversion material,
wherein the wavelength conversion material is arranged on the rotating member, and the wavelength conversion material is configured to convert the laser beam into a conversion beam,
the rotating member is configured to drive the wavelength conversion material to rotate around the rotation axis, and
the wavelength conversion element has a light-transmitting area, the light-transmitting area is surrounded by the rotating member, and the light-transmitting area is configured to allow at least one of the laser beam and the conversion beam to pass through, and
the first light splitting element is arranged on a transmission path of the laser beam and the conversion beam and configured to allow one of the laser beam and the conversion beam to pass through and reflect the other one of the laser beam and the conversion beam, and the illumination beam includes at least one of the first part of the laser beam and the conversion beam,
the at least one light valve is arranged on a transmission path of the illumination beam and configured to convert the illumination beam into an image beam, and
the projection lens is arranged on a transmission path of the image beam and configured to project the image beam out of the projection device.
